(19) United States
(12) Patent Application Publication
(10) Pub. No.: US 2006/0164084 A1
(43) Pub. Date: Jul. 27, 2006

(54) Method and system for enabling adaptive measurement of spin-lattice and spin-spin relaxation times

(75) Inventor: Stephen Lomnes, Albany, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/038,131

(22) Filed: Jan. 21, 2005

(51) Int. Cl. G01V 3/00

(52) U.S. Cl. 324/307

(57) ABSTRACT

A method and system for adaptive acquisition of magnetic resonance imaging (MRI) data by initially performing an analysis of a set of samples using a wide range of spin-lattice relaxation time (T1) times, and spin-spin relaxation time (T2) times of the sample under magnetic resonance imaging, and ranking the level of impact each of those T1s and T2s has on inversion times (TIs) and echo times (TEs) respectively. The method and system create a look-up table based on the data generated, and then perform another measurement using a smaller number of T1s and T2s using a small number of TIs and TEs, and compare the results to the data in the look-up table in order to select the closest point in the look-up table.

### FIELD OF THE INVENTION

The embodiments relate generally to the field of magnetic resonance imaging (MRI), and more specifically to a system and method for acquiring spin-lattice or longitudinal relaxation time.

### BACKGROUND OF THE INVENTION

Acronyms for Magnetic Resonance Imaging
MRI—Magnetic resonance imaging
Bₒ—Static magnetic field
LUT—Look-up table
Φ—Phase angle
T₁—Spin-lattice relaxation time
T₂ Spin-spin relaxation time
θ—Rotation angle
TE—Echo Time
TI—Inversion Time
TR—Repetition Time
M_{X} —X component of magnetization
M_{X′}—X′ component of magnetization
M_{Y}—Y component of magnetization
M_{Y′}—Y′ component of magnetization
M_{Z}—Z component of magnetization
M_{XY}—Transverse component of magnetization
Mₒ—Net magnetization vector

Magnetic resonance imaging (MRI) is a strong imaging modality. In addition to providing contrast resolution and spatial resolution, MRI offers tissue information and data about metabolic processes in the body. An assessment on the human body shows that it is primarily fat and water, and that about 80% of the body's atoms are hydrogen atoms, so most parts of the body have an abundance of sources for the hydrogen nuclear magnetic resonance signals which make up the magnetic resonance image (MRI). MRI provides multiple parameters for obtaining image information, some of which carry a great deal of information, and some of which can be manipulated to obtain a tissue diagnostic image. MRI makes use of the resonance properties of a single proton found in the nucleus of atoms present in the human body. A moving electric charge, be it positive or negative, produces a magnetic field. A significant magnetic field can be produced depending on how large or how fast the charge is. Some of the basic properties of a simple proton include mass, a positive electric charge and spin. A proton does not have a very large electric charge, but it does spin very fast and, therefore, it produces a small, but noticeable, magnetic field.

Just as a compass aligns with the earth's magnetic field, a spinning proton placed near (or within) a large external magnetic field (called Bø) will align with the external field. At the atomic level, some of the protons align with the field and some actually align against the field canceling each other out. A slight excess will align with the field so that the net result is an alignment with the external field. the one that aligns with the field is a lower energy state, while the other is higher energy state, the protons are continually oscillating back and forth between the two states but at any given instant, and with a large enough sample, there will be a very slight majority aligned with the applied field. The larger the applied external Bø field, the greater the difference in energy levels and the larger the excess number aligned with the field. If an electromagnetic radio frequency (RF) pulse is applied at the resonance frequency, then the protons can absorb that energy. At the quantum level, a single proton jumps to a higher energy state. At the macro level the magnetization vector, Mø spirals down towards the XY plane. And when the RF pulse is removed, three things begin to occur a) the absorbed RF energy is retransmitted (at the resonance frequency), which constitute the NMR signal, b) the excited spins begin to return to the original M_{z} orientation (T1 recovery to thermal equilibrium), and c) the excited protons that were in-phase begin to dephase (T2 relaxation).

As stated above, there are two major relaxation processes; spin-lattice (longitudinal) relaxation, or T1 and spin-spin (transverse) relaxation or T2, that provide information about the sample under diagnosis. The sample in which the nuclei are held is called the lattice. Nuclei in the lattice are in vibration and rotational motion, which creates a complex magnetic field. The magnetic field caused by the motion of nuclei within the lattice is called the lattice field. This lattice field has many components, some of which are equal in frequency and phase to the Larmor frequency (so named after Sir Joseph Larmor) of the nuclei of interest. These components of the lattice field can interact with nuclei in a higher energy state, and cause them to lose energy (returning to the lower state). The energy that a nucleus loses increases the amount of vibration and rotation within the lattice (resulting in a tiny rise in the temperature of the sample).

The relaxation time, T₁ (the average lifetime of nuclei in the higher energy state) is dependant on the magnetogyric ratio of the nucleus and the mobility of the lattice. As mobility increases, the vibration and rotational frequencies increase, making it more likely for a component of the lattice field to be able to interact with excited nuclei. However, at extremely high mobility, the probability of a component of the lattice field being able to interact with excited nuclei decreases. T₂ describes the interaction between neighboring nuclei with identical precessional frequencies but differing magnetic quantum states, it is a principle contrast determining processes of the nuclear magnetic resonance phenomenon, which is also known as transverse relaxation and spin-spin relaxation. It is a time constant for loss of phase coherence among spins oriented at an angle to the applied static magnetic field due to interactions between the spins.

The T₁ effect in the relaxation process is due to a return of the high state protons to the low energy state, and is governed by M_{z}=M_{ø}(1−e^{-t/T1}), and if the net magnetization is placed along the −Z axis, it will gradually return to its equilibrium position along the +Z axis at a rate governed by T1; the equation governing this behavior as a function of time after displacement is Mz=Mø(1−2⁻^{-t/T1}). T₁ is therefore, defined as the time required to change the Z component of magnetization by a factor of e.

Over the time period T₁ the high state protons exchange the “extra” energy with the neighboring protons, resulting in heat and thermal energy. The relaxation process is a result of both T₁ and T₂, and due to the exponential nature of this process some tissues might not be distinguishable, if recording the signal in the xy-plane directly. For that reason it is necessary to introduce control of the relaxation process by introducing a dependency of one of the two biological parameters in the recorded signal. The value of T₁ is dependent of the protons ability to exchange the energetic field variation of zero, resulting in a long T₂ period.

When the spins are first tilted from the Z-axis and down to the XY plane, they are all in phase, but some protons spin a little faster than others, and very quickly, the spins get out of phase, and as protons (or spins) move together, their magnetic fields begin to interact. If the field from one proton augments the field that the second proton feels, then the second proton will precess at a slightly faster rate. If the first field opposes the main field then the second proton will precess more slowly. As soon as the spins move farther apart from each other, their fields no longer interact and they both return to the original frequency but at different phases. This type of interaction is called spin-spin interaction, or T2 relaxation time, and is governed by M_{xy}=M_{xyø}*e^{-t/T2}. The T₂ effect in the relaxation process is due to de-phasing of the individual protons' magnetic dipole moment (MDM), because of the existence of a non-stationary magnetic field. Each proton will experience the external, stationary magnetic field B_{ø} along with the self generated magnetic field of the neighboring protons. Since the angular frequency of a proton is proportional to the experienced magnetic field, the protons will precess at different frequencies, depending on the actual field. When the protons precess at different frequencies, some MDM's will be ahead and other behind compared to the ideal frequency—the Larmor frequency, resulting in a net decrease of magnetic moment in the xy-plane as time goes on. At some point, the magnetic moment will become zero, when all the MDM's equalize one another. The time period from maximum value to zero is characterized by T₂. The value of T₂ depends on the mobility of the protons, since a large mobility results in an average magnitude T₁ effect.

Inversion recovery (IR) is an imaging sequence that involves successive 180° and 90° pulses, after which a heavily T1-weighted signal is obtained. The inversion recovery sequence is specified in terms of three parameters, inversion time (T1) which is the time period between a 180° inversion pulse and a 90° excitation pulse in an inversion recovery pulse sequence, repetition time (TR), which is the time over which a basic pulse sequence is repeated to acquire all the necessary imaging lines and echo time (TE) that represents the time in milliseconds between the application of the 90° pulse and the peak of the echo signal in spin echo and inversion recovery pulse sequences. IR is an important parameter pulse sequence for targeted magnetic resonance probes, and in order to acquire a T1, one must take multiple images of the same sample at different inversion times (TI), that is the time after a middle of inverting RF pulse to middle of 90° pulse used to monitor the amount of longitudinal magnetization. The precision of the measurement of TIs is a function of the number of distinct TIs one use for the measurement, and as a result the more TIs used, the longer it takes to acquire T1 measurements, consequently, the precision of the measurements is which is dependent on TI suffers as a result.

Unfortunately, conventional methods for acquiring T1 and T2 are not accurate and consequently time consuming and tedious. Accordingly, there is a need in the art of magnetic resonance imaging for fast and accurate acquisition times for T1 and T2.

The description herein of disadvantages and deleterious properties associated with known methods and systems is not intended to limit the scope of the embodiments of the invention to their exclusion. Indeed, certain embodiments of the invention may incorporate parts or all of known systems and methods without suffering from the disadvantages and deleterious properties.

### SUMMARY OF THE INVENTION

Certain aspects commensurate in scope with various embodiments of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

It is a feature of an embodiment of the invention to provide an MRI method for acquiring accurate and fast measurement parameters of a sample, by analyzing a set of samples with a wide range of T1s, using a wide range of TIs (for example five times the number of T1s), and by analysis, compare and rank the level of impact each TI has on the precision on the T1 measurements. From the ranking and comparison, the method then constructs a look-up table. Afterwards, the method performs measurements with a standard set of TIs (for example, 3), and estimates the T1s from it. Finally, the method compares the result of the measurement to the data in the look-up table, and then performs a next scan.

Another method in accordance with a feature of an embodiment of the invention is characterized in that a measurement is made with a number of TIs, for example 3, and then certain approximation functions are enlisted to reduce any errors, such as linear regression analysis using least squares fit, so that the method can provide good guesses for the next best point. Another such approximation function is the Min-Max method, where for instance, if one result from an analysis is between two values, then the next TI should be a value closer to that value, and therefore, through iteration, the estimated error is minimized.

Another feature of an embodiment of the invention employs an analytical method in acquiring TIs. Through statistical techniques, the method searches at what specific TI the greatest error would be, then selects that TI for the next measurement, and iteratively estimates the measurement error until a desired range is achieved.

Another feature of an embodiment of the invention is a computational algorithm that runs in parallel with the acquisition mechanism, namely the MRI scanner. The algorithm would adaptively direct the acquisition device to take measurements at the next most valuable point without the device having any prior knowledge of the sample, or having any user intervention, with a predetermined desired precision.

### BRIEF DESCRIPTION OF THE DRAWINGS

The features of the invention believed to be novel are set forth with particularity in the appended claims. The invention itself, however, both as to organization and method of operation, together with further objects and advantages thereof, may best be understood by reference to the following description taken in conjunction with the accompanying drawings, where like numerals represent like components, in which:

FIG. 1 is a graphic representation of an MRI scanner.

FIG. 2 is a repetition time (TR) of a 180 degree pulse, followed by a 90° pulse, with an associated inversion time (TI).

FIG. 3 is a graph showing the transverse decay described by T2 (spin-spin) relaxation time, with a number of Echo Times (TEs), according to a feature of an embodiment.

FIG. 4 is a graph showing the longitudinal relaxation described by T1 (spin-lattice) relaxation time from a number of inversion pulses (TIs), according to an embodiment of the present invention.

FIG. 5 is a flow chart illustrating steps of acquiring accurate sample measurements using a wide range of T1s and TIs according to an embodiment of the present invention.

FIG. 6 is a flow chart illustrating steps of acquiring TIs in an accurate and more efficient way by reducing any errors according to an embodiment of the present invention.

FIG. 7 is a flow chart illustrating steps of acquiring T2 with a wide range of TEs in an accurate and more efficient way according to an embodiment of the present invention.

### DETAILED DESCRIPTION OF THE PREFERRED EMBODIMENTS

While only certain preferred features of the embodiments have been illustrated and described herein, many modifications and changes will occur to those skilled in the art. It is, therefore, to be understood that the appended claims are intended to cover all such modifications and changes as fall within the true spirit of the embodiments.

Atomic nuclei are composed of protons and neutrons, each having a property called a “spin” that behaves like an angular momentum and which imparts a net magnetic state to the nucleus. Spin is essentially what nuclear magnetic resonance measures. The spins of the protons are opposite to the spin of the neutrons, thereby canceling each other resulting in a net nuclei spin of zero. Few atoms with unpaired protons or neutrons don't have this canceling effect and thus have a net angular momentum. Hydrogen is the best example of such unpaired atoms and also it is the most abundant in the human body. MRI is based on such hydrogen-containing molecules including proteins, fats, carbohydrates, and nucleic acids. The strongest signals, however, come from the hydrogen in free water molecules. When exposed to an external magnetic field, often abbreviated as B₀ hydrogen atoms will align with that field either parallel (in the same direction) or anti-parallel to it. Protons that align parallel are in a lower energy state than those aligned antiparallel.

As one might expect, more protons will align parallel than anti parallel. It can be imagined that the magnetic moments have lined up with the field to give the body a net magnetization, M₀, parallel and proportional to B₀. The application of an RF field at the Larmor frequency perpendicular to B₀ will cause the nuclei to become excited which in turn causes the net magnetization vector M₀ to precess about B₀. When the RF signal is removed the net magnetization decays to its equilibrium alignment, emitting an RF signal at the Larmor frequency. This signal can be detected by a receive coil and used for MRI. Combining the ideas of spin, precession, and applied field alignment, one can envision how a group of protons will act in a magnetic field. In order for the MRI machine to be able to pick up a signal, Mₒ must be pushed out of the longitudinal plane (z-axis) and into the transverse plane (x-y plane).

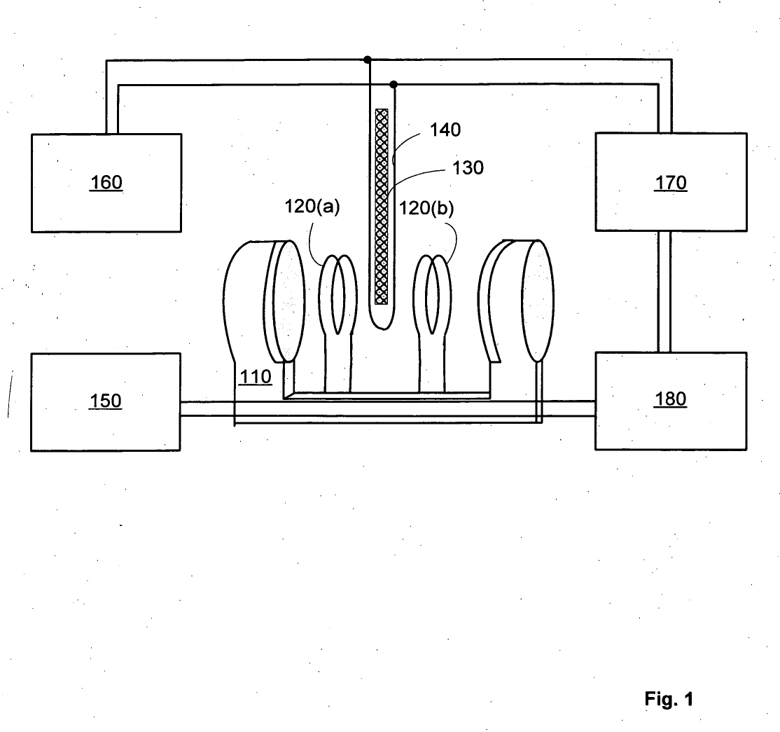

FIG. 1 is a depiction of a magnetic resonance imaging equipment, that comprise magnets 110, that constantly generate a magnetic field, resistance coils 120(a), and 120(b), horizontal cavity 140 running through the magnet, known as the bore of the magnet, and where the sample 130 is placed, radio frequency generator 160 for driving the magnet coils, an RF amplifier 170 for amplifying the received RF signal, a sweep generator 150, that provides an accurate display of reflection or (VSWR) versus frequency, and a recorder 180 for displaying the data.

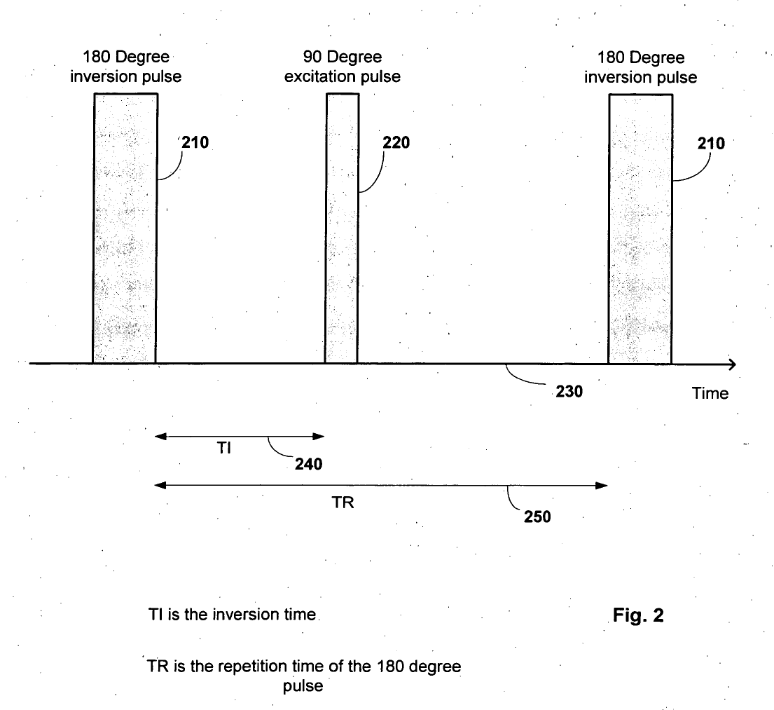

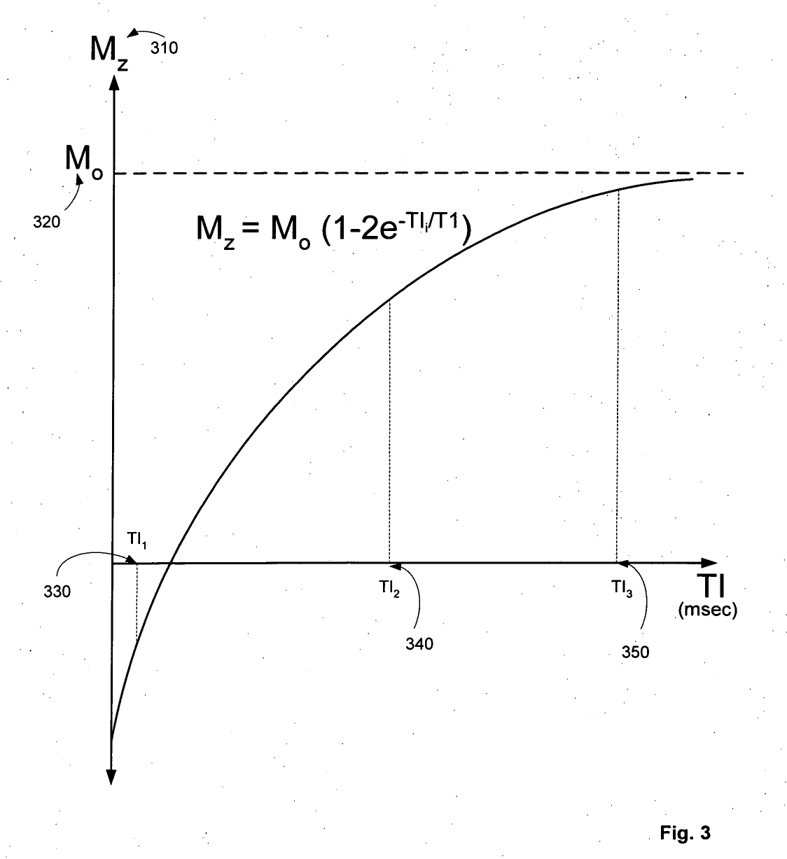

In order to extract T1 or spin-lattice relaxation, an inversion recovery pulse sequence is used, and T2 or spin-spin relaxation is acquired using a standard spin echo (SE) pulse sequence. In reference to FIG. 2, the inversion recovery pulse sequence utilizes a 180° inversion pulse 210, followed by a 90° excitation pulse 220, that effectively changes the size of the dipole that the receiver coil of FIG. 1 sees after the 90° pulse. The amplitude of that signal is a function of time, TI 240 between the 90° excitation pulse and 180° inversion pulse. TI is known as the inversion time. In reference to FIG. 3, amplitude of the signal intensity as a function of the inversion time (TI), yields the exponential curve from which the spin-lattice relaxation (T1) may be extracted. Embodiments of the invention select a small number TIs to derive enough T1s to generate the graph shown in FIG. 3. Likewise, after an RF pulse has been applied to generate a processing coherent transverse magnetization M_{xy}, the energy of the spins of all the nuclei will be redistributed and the transverse magnetization will decay away as the spins ‘dephase,’ or in other words, become out of phase. At some point in time after the 90° pulse, a 180° pulse is applied, which rotates the magnetization by 180° about the X axis, which causes the magnetization to at least partially become in phase, and produce an echo as shown in FIG. 2. The time between the middle of the 90° pulse, and the middle of the spin echo production is known as echo time (TE), and is used to calculate the spin-spin or transverse relaxation time (T2).

In reference to FIG. 3, at equilibrium, the net magnetization vector lies along the direction of the applied magnetic field Bₒ and is called the equilibrium magnetization Mₒ 320. In this configuration, the Z component of magnetization M_{Z} 310 equals Mₒ 320. M_{Z} is referred to as the longitudinal magnetization, and there is no transverse (M_{X} or M_{Y}) magnetization. When a 180° RF pulse is applied it will invert the longitudinal magnetization 310. The longitudinal magnetizations 310 will then recover towards its equilibrium distribution with a time constant T₁. However if after a time TI (known as the inversion time) a 90° pulse is applied, it will flip the longitudinal magnetization existing at that time into the xy plane. To measure T₁, the method and system of the embodiments begin with a one-time analysis of a set of MRI samples with a wide range of T1s. Using the wide range of TIs, the method and system tabulates the precision level of each measurement, ranks the most precise TI/T1 combination as the highest, and creates a look-up table. The method and system then estimates T1 measurements using a small number of TIs, such as 330 (FIG. 3) and the result is compared with the T1 measurements from the look-up table. The method then selects the closest T1 in the look-up table to the T1 estimated measurement. Once the closest T1 in the look-up table is chosen from the corresponding TIs, the next highest TI, such as 340 from the look-up table is chosen, measurements are taken, and the process repeats by picking the next highest TI from the look-up table, such as 350. This system and method make it possible to sample M_{z} 310 during the recovery of the longitudinal magnetization without using a large number of TIs. The spin-lattice relaxation is calculated using:
T1=ln(M_{xy}/M₀)/TIᵢ where i=1, . . . 3

A 90° pulse is applied that flips the longitudinal magnetization M_{z} into the xy plane, resulting in a transverse magnetization M_{xy} 410. Following the 90° pulse, the spins begin to dephase, and another RF pulse is applied that flips the spins 180 degrees, the pulse inverts the phase of the spins and places the faster precessing spins behind the slower ones causing the transverse magnetization M_{xy} 410 to become refocused at a time called echo time (TE). Spin-spin or T2 relaxation occurs when the spins in the high and low energy state exchange energy but do not loose energy to the surrounding lattice.

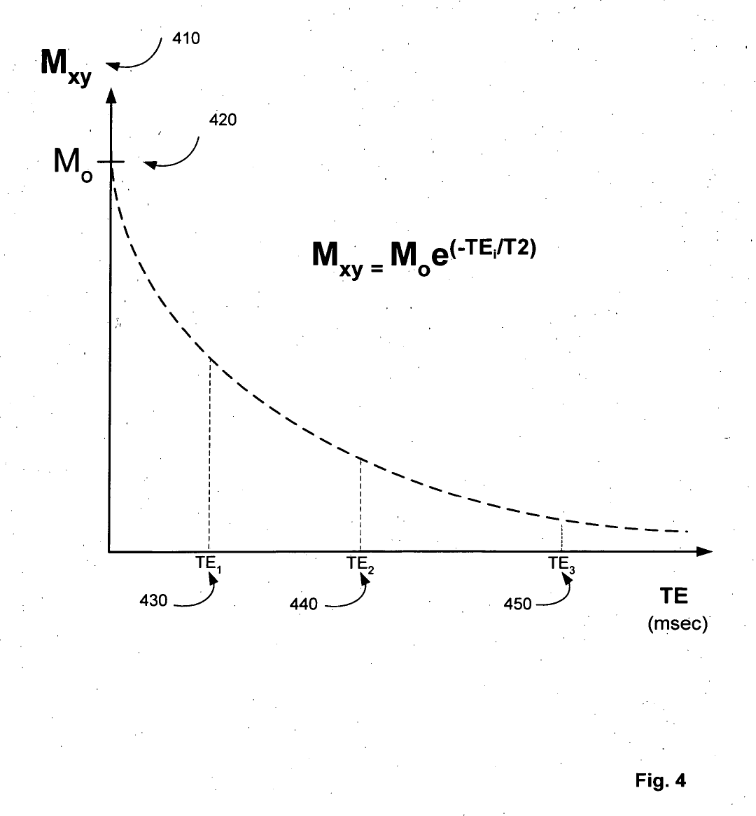

Turning now reference to FIG. 4, the method and system of an embodiment utilizes a small number of Echo Times (TE) to acquire accurate and fast measurement parameters of a sample. The method and system begins with performing an initial one-time analysis of a set of MRI samples with a wide range of T2s using the wide range of TEs, then each TE is ranked on how much impact it has on the precision of the corresponding TE. After tabulating all of the precisions, a look-up table is created. The actual measurement is accomplished utilizing a small number TEs, preferably three. In reference to FIG. 4, TE₁ 430 is used to measure T2, and the result is compared with the initially tabulated T2 measurements from the look-up table. The system and method then selects the closest T2 in the look-up table to the T2 estimated measurement. Once the closest T2 in the look-up table is chosen from the corresponding TEs, the next highest TE₂ 440 from the look-up table is chosen, measurements are taken, and the process repeats by picking the next highest TE₃ 450 from the look-up table, to achieve the transverse magnetization M_{xy} 410 decay. The spin-spin relaxation is calculated using:
T2=−ln(M_{xy}/M₀)/TEᵢ where i=1, . . . 3

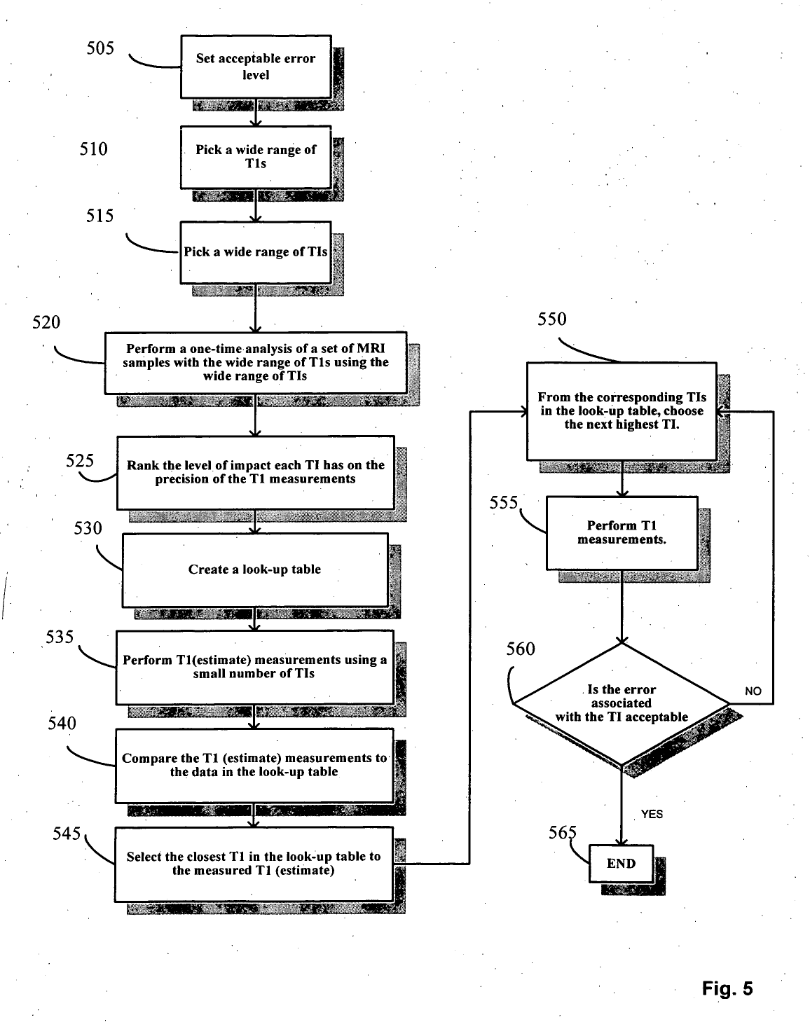

A preferred embodiment of an MRI method for acquiring accurate and fast measurement parameters of a sample is accomplished by analyzing a set of samples with a wide range of T1s, using a wide range of TIs (for example five times the number of T1s). In reference to FIG. 5, the method preferably begins with step 505, where an initial acceptable error level is set followed by step 510, where a wide range of T1s are chosen followed by a selection of a wide range of TIs in step 515. Then in step 520, a one-time analysis of a set of MRI samples is performed with the wide range of T1s using the wide range of TIs. In step 525, the impact that each TI has on the precision of the T1 measurements is observed and as a result, the TIs are ranked in accordance with the impact, then tabulated in a look-up table in step 530. In step 535, T1 estimate measurements are made using a small number of TIs, for example, three TIs, and the result is compared with the T1 measurements from the look-up table in step 540.

The method then selects the closest T1 in the look-up table to the T1 estimated measurement in step 545. Once the closest T1 in the look-up table is chosen from the corresponding TIs, the next highest TI from the look-up table is chosen in step 550, and a new T1 measurement is performed in step 555. In step 560, the system and method checks whether the error associated with the TI is acceptable to the error level set in step 505. If the error is an acceptable level, the process ends in step 565, thereby finding the number of TIs needed to calculate a small number of T1s. If the error is not an acceptable level, the system and method performs an iteration by choosing the next highest TI in the look-up table to perform a new T1 measurement until the error level is acceptable to the user, thereby facilitating the use of a small number of T1s and associated number of TIs to acquire an image of the sample.

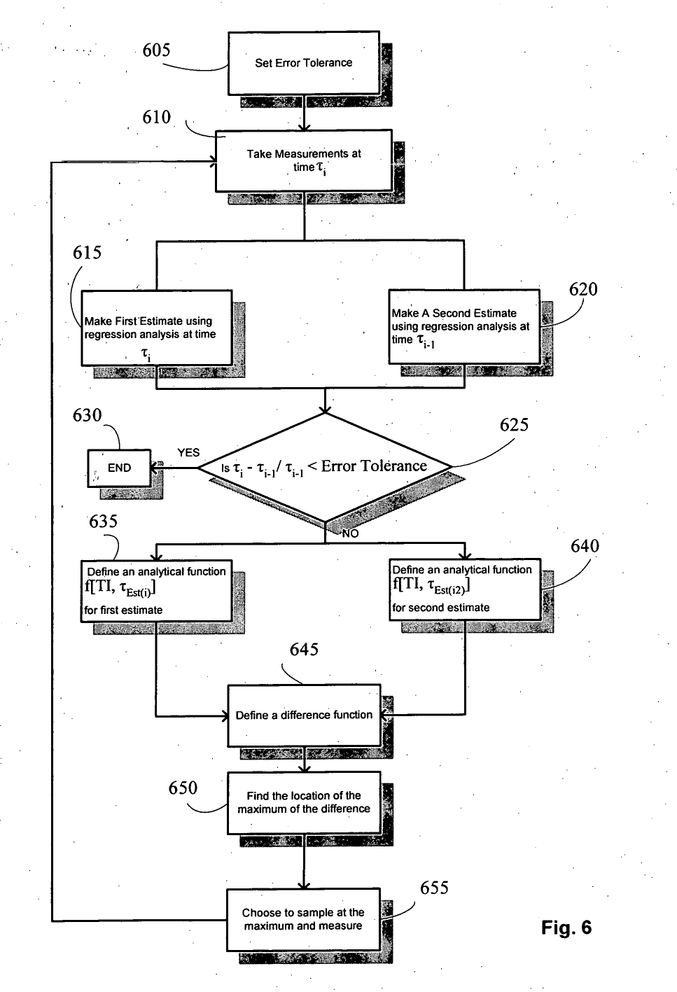

Another feature of an embodiment employs an analytical method in acquiring TIs, through statistical techniques, the method searches at what specific TI the greatest error would be, then selecting that TI for the next measurement, and iteratively estimating the measurement error until a desired range is achieved. Turning now to FIG. 6, the system and method begin with setting a tolerance level for the error in step 605, they then take TI measurements at a specific time τᵢ at step 610, and then with the use of an approximation method, such as regression analysis using least squares, a first estimate is made in step 615. A second measurement and an estimate is made at time τᵢ₋₁ at step 620. In step 625, a relative error of the two estimates is computed and compared to the tolerance level set in step 605. If the result is less than the tolerance level, the method is ended, otherwise an analytical function for the estimates is separately defined in steps 635, and 640. In step 645, a difference equation is defined, and the location of the maximum of the difference is determined in step 650, then at that maximum location, a sample is chosen and measurements are made in step 655. The method is iterated to start again at step 610 until the estimates are less than the required tolerance.

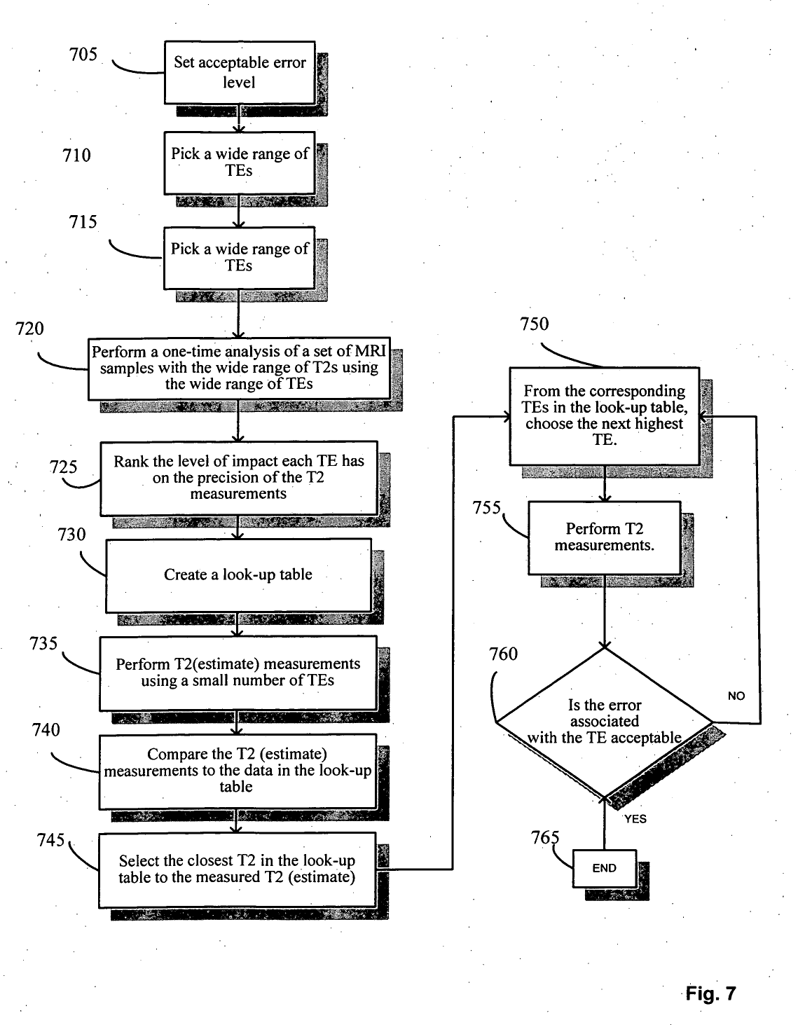

According to another embodiment, an MRI method for acquiring accurate and fast measurement parameters of a sample includes analyzing a set of samples with a wide range of T2s, using a wide range of TEs (for example five times the number of T2s). With reference to FIG. 7, the method begins at step 705, where an initial acceptable error level is set followed by step 710, where a wide range of T2s are chosen followed by a selection of a wide range of TEs in step 715. Then in step 720, a one-time analysis of a set of MRI samples is performed with the wide range of T2s using the wide range of TEs. In step 725, the impact that each TE has on the precision of the T2 measurements is observed and as a result, the TEs are ranked in accordance with the impact, and tabulated in a look-up table in step 730. In step 735, T2 estimate measurements are made using a small number of TEs, for example, three TEs, and the result is compared with the T2 measurements from the look-up table in step 740. The method then selects the closest T2 in the look-up table to the T2 estimated measurement in step 745.

Once the closest T2 in the look-up table is chosen, from the corresponding TEs, the next highest TE from the look-up table is chosen in step 750, and a new T2 measurement is performed in step 755. In step 760, the system and method preferably checks whether the error associated with the TE is acceptable to the error level set in step 705. If the error is an acceptable level, the process ends in step 765, thereby finding the number of TIs needed to calculate a small number of T2s. On the other hand, if the error is not an acceptable level, the method and system performs an iteration by choosing the next highest TE in the look-up table to perform a new T2 measurement until the error level is acceptable to the user. The system and method thereby facilitate the use of a small number of T2s and associated number of TEs to acquire an image of the sample.

Another embodiment includes a computational algorithm that runs in parallel with the acquisition mechanism, namely the MRI scanner. The algorithm would adaptively direct the acquisition device to take measurements at the next valuable point with a predetermined desired precision, and without the device having any prior knowledge of the sample, or having any user intervention.

Other embodiments, uses, and advantages of the invention will be apparent to those skilled in the art from consideration of the specification and practice of the invention disclosed herein. The specification and drawings should be considered exemplary only, and the scope of the invention is accordingly intended to be limited only by the following claims and equivalents thereof.

What is claimed is:

1. A method of iteratively measuring spin-lattice relaxation times (T1) the method comprising:
setting an acceptable error level;
initially selecting a wide range of spin-lattice relaxation times (T1), and a corresponding number of inversion times (TI);
analyzing a set of samples with a wide range of inversion times;
ranking the level of impact each inversion time has on the precision of the spin-lattice relaxation time measurement;
constructing a look-up table for the spin-lattice relaxation time measurement and the associated inversion times;
performing a spin-lattice relaxation time measurement using a small number of inversion times;
selecting the spin lattice relaxation time, and associated inversion time in the look-up table that is closest to the measured spin-lattice relaxation time; and
utilizing the next highest inversion time in the look-up table to perform a new spin-lattice relaxation time.

2. The method as defined by claim 1, wherein the small number of inversion times are three.

3. The method as defined by claim 1, wherein the spin-lattice relaxation times is calculated by the following equation:
T1=ln(M_{xy}/M₀)/TIᵢ where i=1, . . . 3

4. The method as defined by claim 1, wherein the spin-lattice measurements are compared to data in the look-up table.

5. The method as defined by claim 4, wherein the closest spin-lattice measurement in the look-up table to the measured spin-lattice is selected, and the corresponding inversion time is chosen.

6. The method of claim 1, wherein the iterative spin-lattice relaxation times measurement is performed until the error associated with the measurement is less than or equal to the acceptable error level.

7. A method of iteratively measuring spin-spin relaxation times (T2), the method comprising:
setting an acceptable error level;
selecting a wide range of spin-spin relaxation times (T2), and a corresponding number of echo times (TE);
analyzing a set of samples with a wide range of echo times;
ranking the level of impact each echo time (TE) has on the precision of the spin-spin relaxation times measurement;
constructing a look-up table data for the spin-spin relaxation time measurement as well as the associated echo times; and
performing a spin-spin relaxation measurement using a smaller number of echo times, and comparing the results to the look-up table data;
selecting the spin-spin relaxation time in the look-up table data that is closest to the measured spin-spin relaxation time.

8. The method as defined by claim 7 wherein the spin-spin relaxation times are calculated by the following equation:
T2=−ln(M_{xy}/M₀)/TEᵢ where i=1, . . . 3

9. The method as defined by claim 7 wherein the spin-spin measurements are compared to data in the look-up table.

10. The method as defined by claim 9 wherein the closest spin-spin measurement in the look-up table to the measured spin lattice is selected, and the corresponding echo time is chosen.

11. A system for iteratively measuring spin-lattice relaxation times (T1), the system comprising:
setting an acceptable error level;
initially selecting a wide range of spin-lattice relaxation times (T1), and a corresponding number of inversion times (Ti);
analyzing a set of samples with a wide range of inversion times;
ranking the level of impact each inversion time has on the precision of the spin-lattice relaxation time measurement;
constructing a look-up table for the spin-lattice relaxation time measurement as well as the associated inversion times;
performing a spin-lattice relaxation time measurements using a small number of inversion times;
selecting the spin lattice relaxation time, and associated inversion time in the look-up table that is closest to the measured spin-lattice relaxation time; and
utilizing the next highest inversion time in the look-up table to perform a new spin-lattice relaxation time.

12. The system of claim 11, wherein the spin-lattice relaxation times is calculated by the following equation:
T1=ln(M_{xy}/M₀)/TIᵢ where i=1, . . . 3

13. The system of claim 11, wherein the spin-lattice measurements are compared to data in the look-up table.

14. The system of claim 13, wherein the closest spin-lattice measurement in the look-up table to the measured spin-lattice is selected, and the corresponding inversion time is chosen.

15. The system of claim 11, wherein the iterative spin-lattice relaxation times measurement is performed until the error associated with the measurement is less than or equal to the acceptable error level.

16. A system of iteratively measuring spin-spin relaxation times (T2), the system comprising:
setting an acceptable error level;
selecting a wide range of spin-spin relaxation times (T2), and a corresponding number of echo times (TE);
analyzing a set of samples with a wide range of echo times;
ranking the level of impact each echo time (TE) has on the precision of the spin-spin relaxation times measurement;
constructing a look-up table data for the spin-spin relaxation time measurement as well as the associated echo times; and
performing a spin-spin relaxation measurement using a smaller number of echo times, and comparing the results to the look-up table data;
selecting the spin-spin relaxation time in the look-up table data that is closest to the measured spin-spin relaxation time.

17. The system of claim 16, wherein said spin-spin relaxation times are calculated by the following equation:
T2=−ln(M_{xy}/M₀)/TEᵢ where i=1, . . . 3

18. The system of claim 16, wherein the spin-spin measurements are compared to data in the look-up table.

19. The system of claim 18, wherein the closest spin-spin measurement in the look-Up table to the measured spin lattice is selected, and the corresponding echo time is chosen.
